(19) United States
(12) Patent Application Publication
(10) Pub. No.: US 2015/0377126 A1
(43) Pub. Date: Dec. 31, 2015

(54) Combined Gas Turbine Auxiliary Systems

(71) Applicant: General Electric Corporation, Schenectady, NY (US)

(72) Inventors: James Harper, Greenville, SC (US); Jason Randolph Marshall, Moore, SC (US)

(21) Appl. No.: 14/318,865

(22) Filed: Jun. 30, 2014

(51) Int. Cl. F02C 3/30; F23R 3/34; F02C 6/08

(52) U.S. Cl. CPC F02C 3/30; F02C 6/08; F23R 3/346

(57) ABSTRACT

The present application provides a gas turbine engine. The gas turbine engine may include a compressor, a combustor, a number of auxiliary systems, and a common auxiliary system manifold. The common auxiliary system manifold is in communication with the compressor, the combustor, and the auxiliary systems.

### TECHNICAL FIELD

The present application and the resultant patent relate generally to gas turbine engines and more particularly relate to combined gas turbine auxiliary systems using a common manifold for power augmentation and reduced emissions. The auxiliary systems may include compressor inlet bleed heating, air bypass, steam injection, secondary combustion, and the like for improved overall efficiency and output.

### BACKGROUND OF THE INVENTION

Operational efficiency of a gas turbine engine generally increases as the temperature of the hot combustion gas stream increases. Higher combustion gas stream temperatures, however, may result in the production of higher levels of nitrogen oxides (NOₓ) and other types of undesirable emissions. Such emissions may be subject to both federal and state regulations in the United States and also may be subject to similar regulations abroad. Moreover, financing of gas turbine engines and power plants often may be subject to international emissions standards. A balancing act thus exists between operating a gas turbine engine within an efficient temperature range while also ensuring that the output of nitrogen oxides and other types of regulated emissions remain well within mandated levels. Many other types of operational parameters also may be varied in providing such an optimized balance.

Different types of emissions reduction and/or power augmentation systems may be used. For example, secondary combustion or lean late injection may provide an air/fuel mixture downstream in a combustor to achieve improved emissions performance. The secondary combustion systems also may be used to provide bypass air for reduced emissions during “turndown” or low load operations. Different types of inlet bleed heat systems also are known. An inlet bleed heat system may provide hot compressor discharge air to the compressor air inlet to elevate the temperature of the incoming airstream so as to improve emissions during part load operations. Likewise, different types of power augmentation systems are known. For example, these power augmentation system may provide steam to the compressor discharge plenum or elsewhere to increase the mass flow of the air entering the combustor so as to improve overall power output. These various emissions reduction and power augmentation systems, however, often may be complex and may require various types of parasitic power and the like to operate. Each of these auxiliary systems also may require its own control system and hardware.

There is thus a desire for a gas turbine engine with simplified emissions reduction, power augmentation, and other types of auxiliary systems. Such simplified auxiliary systems may be less complex and hence more reliable in operation while providing improved overall system efficiency and output with reduced parasitic power drains.

### SUMMARY OF THE INVENTION

The present application and the resultant patent thus provide a gas turbine engine. The gas turbine engine may include a compressor, a combustor, a number of auxiliary systems, and a common auxiliary system manifold. The common auxiliary system manifold is in communication with the compressor, the combustor, and the auxiliary systems.

The present application and the resultant patent further provide a method of operating a gas turbine engine. The method may include the steps of providing a common auxiliary system manifold in communication with a compressor and a combustor of the gas turbine engine, providing a flow of compressor discharge air to the common auxiliary system manifold, and directing the flow of compressor discharge air to an inlet bleed heat system positioned about the compressor and to the combustor as a bypass flow.

The present application and the resultant patent further a gas turbine engine. The gas turbine engine may include a compressor, a combustor, a number of auxiliary systems, and a common auxiliary system manifold. The common auxiliary system manifold may include a manifold extraction line, a manifold bypass line, and a three-way valve therebetween.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine with a number of auxiliary systems.

FIG. 2 is a schematic diagram of a gas turbine engine with a common auxiliary system manifold as may be described herein in communication with a number of auxiliary systems.

FIG. 3 is a partial schematic diagram of the common auxiliary system manifold of FIG. 2.

FIG. 4 is a partial sectional diagram of a portion of the common auxiliary system manifold of FIG. 2.

### DETAILED DESCRIPTION

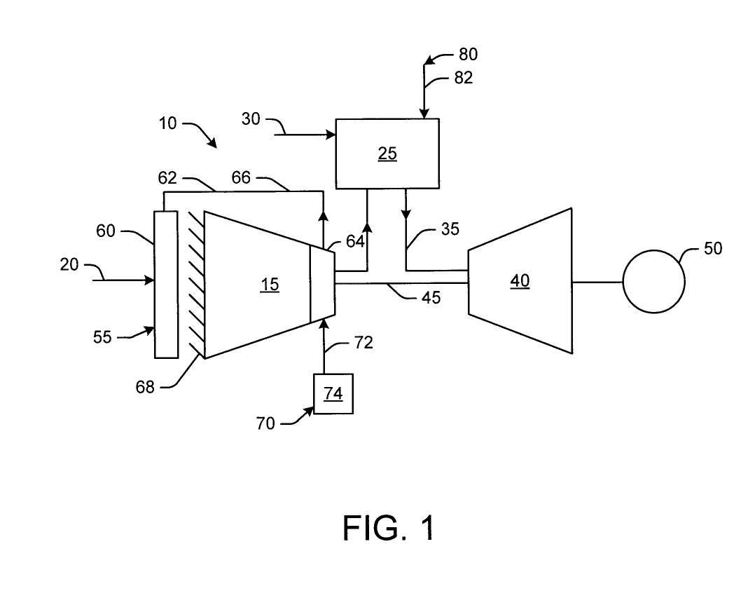

Referring now to the drawings, in which like numerals refer to like elements throughout the several views, FIG. 1 shows a schematic view of gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25 positioned in a circumferential array or otherwise. The flow of combustion gases 35 is delivered in turn to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like.

The gas turbine engine 10 may use natural gas, liquid fuels, various types of syngas, and/or other types of fuels and blends thereof. The gas turbine engine 10 may be any one of a number of different gas turbine engines offered by General Electric Company of Schenectady, New York, including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together.

As described above, the gas turbine engine 10 may include a number of auxiliary systems 55. These auxiliary systems 55 may include an inlet bleed heat system 60. Generally described, the inlet bleed heat system 60 may include an extraction line 62 extending from a compressor discharge casing 64 of the compressor 15. An extraction of compressor discharge air 66 thus may be forwarded to an inlet of the compressor 15 to warm the incoming flow of air 20. The compressor 15 also may include a number of inlet guide vanes 68 thereon to direct the flow of air 20 into the compressor 15 at any angle.

The auxiliary systems 55 also may include a steam augmentation system 70. Generally described, the steam augmentation system 70 may direct a flow of steam 72 from a steam source 74 to the compressor discharge casing 64 or the combustor 25. The flow of steam 72 may increase the mass flow of the air 20 entering the combustor 25 for an increase in overall power output as described above.

The auxiliary systems 55 also may include a secondary combustion system and/or a late lean injection system 80. Generally described, a further flow of fuel 82 may be mixed with a flow of compressor discharge air and injected downstream in the combustor 25. The secondary combustion system 80 thus provides staged combustion for increased overall power and improved emissions. The compressor discharge air also may be used as bypass air. Other types of emissions, power augmentation, and auxiliary systems may be used herein other configurations and with other components and capacities. The auxiliary systems 55 described herein are for the purpose of example only.

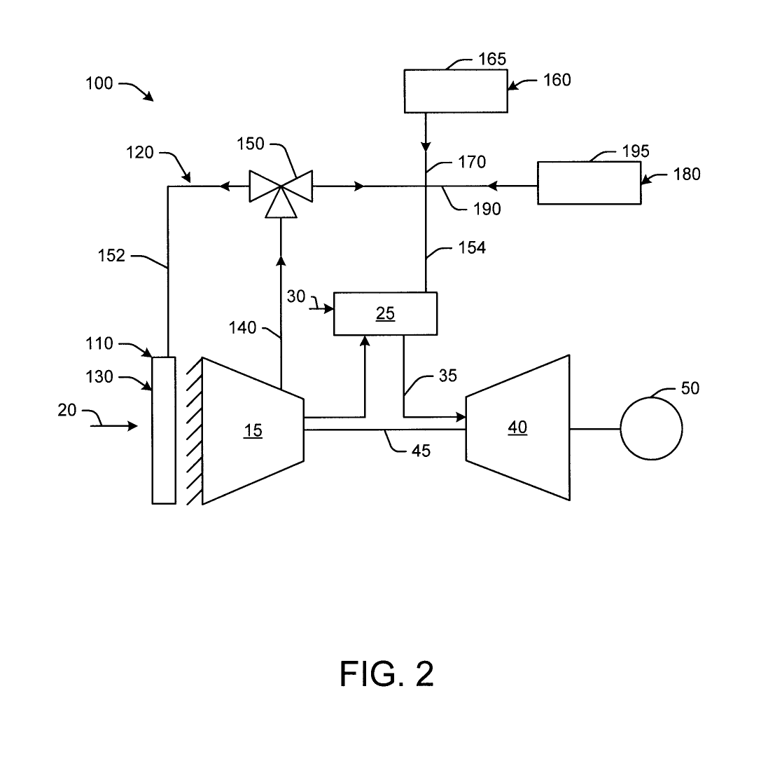

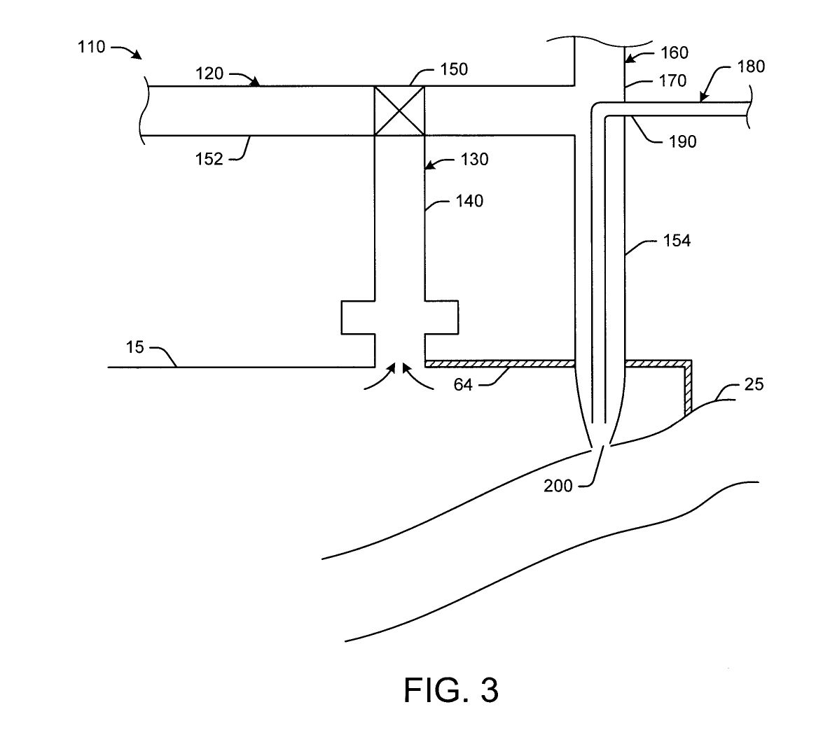

FIGS. 2-4 show a gas turbine engine 100 as may be described herein. The gas turbine engine 100 may include a number of auxiliary systems 110. The auxiliary systems 110 may be similar to those described above and/or may include other systems and other types functionality. The gas turbine engine 100 may include a common auxiliary system manifold 120 connecting some or all of these auxiliary systems 110 and other components. The common auxiliary system manifold 120 may have any suitable size, shape, or configuration and may be used with any number of the auxiliary systems 110.

The auxiliary systems 110 may include an inlet bleed heat system 130. Similar to that described above, the inlet bleed heat system 130 may include an inlet bleed heat extraction line 140. The inlet bleed heat extraction line 140 may be in communication with the common auxiliary system manifold 120 and the compressor discharge casing 64 or elsewhere. The inlet bleed heat extraction line 140 may meet the common auxiliary system manifold 120 at a three-way valve 150 or other type of connection. The three-way valve 150 may be of conventional design. Other types of air direction devices may be used herein. Operation of the three-way valve 150 may deliver an extraction of the compressor discharge air 66 to the compressor 15 as bleed heat via a manifold extraction line 152 or to the combustor 25 as bypass air via a manifold bypass line 154. The compressor discharge air 66 may be used for any suitable purpose. The volume of compressor discharge air 66 and the destination of the compressor discharge air 66 may be varied by the three-way valve 150 depending upon the load and other types of operational parameters. Other components and other configurations may be used herein.

The auxiliary systems 110 herein also may include a steam augmentation system 160. Similar to that described above, the steam augmentation system 160 may include a steam line 170 in communication with the combustor 25 and a steam source 165 via the common auxiliary system manifold 120. The steam augmentation system 160 may deliver the flow of steam 72 to the combustor 25 or elsewhere via the manifold bypass line 154 of the common auxiliary system manifold 120 so as to increase the mass flow rate therethrough. Other components and other configurations also may be used herein.

The auxiliary systems 110 also may include a secondary combustion system 180. Similar to that described above, the secondary combustion system 180 may include a secondary fuel line 190. The secondary fuel line 190 may be in communication with the combustor 25 and a secondary fuel source 195 via the common auxiliary system manifold 120. Specifically, the secondary fuel line 190 may be coaxially positioned within manifold bypass line 154 and may terminate just upstream of the entrance into combustor 25 with a gap therebetween. Other components and other configurations and other configurations may be used herein.

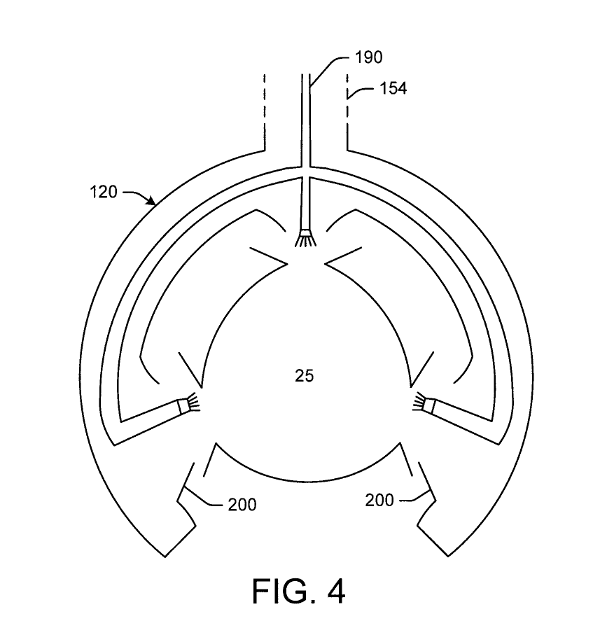

As is shown in FIG. 4, the common auxiliary system manifold 120 may have a number of combustor entry ports 200. Any number of combustor entry ports 120 may be used herein for the various flows herein. The combustor entry ports 120 may have any desired position about the combustor 25 or elsewhere. Other components and other configurations may be used herein. Other types of auxiliary systems 110 may be used herein. The overall gas turbine controls may operate the auxiliary systems 110 and the common auxiliary system manifold 120 and/or a dedicated auxiliary system controller may be used.

The common auxiliary system manifold 120 thus may be used to provide inlet bleed heating to the compressor 15 as well as bypass air, steam, secondary fuel, and the like to the combustor 25 or elsewhere. The inlet bleed heating air and the bypass air may be fed from the inlet bleed heat extraction line 140 and directed via the three-way valve 150 into either the manifold extraction line 152 or the manifold bypass line 154. Alternatively, the airflow may be used with the flow of steam and/or flow of fuel for secondary combustion within the combustor 25. The airflow may be used for any suitable purpose. The steam-air-fuel injection may not attach directly to the combustor 25 so as to allow passive dilution air bypass. The bypass air may serve to increase airflow through a dilution section when in use. Likewise, the steam may bypass most of the combustor 25 so as to reduce the overall effect on the head end and reduce the chance of lean blowout or combustion dynamic issues.

Current gas turbine engine systems may use inlet bleed heat in operation at full speed, no load conditions. The use of the common auxiliary system manifold 120, however, allows the use of bypass air until near overall base load operations. The bypass air may serve to increase the combustor head end temperatures so as to improve combustion operability at lower firing temperatures and increase emissions compliant turndown. The bypass air also may serve to reduce combustor pressure drop and improve cycle efficiency (heat rate) so as to reduce fuel burn in part load operation. A bypass airflow of about five percent (5%) may improve the overall heat rate by more than about one percent (1%). Other types of loading paths and other types of operational parameters may be accommodated herein.

Emissions compliant turndown may improve by about fifty degrees (50°) Fahrenheit (about ten degrees (10°) Celsius) of current overall capability. Such an improvement may correspond to about two percent (2%) or more in load depending upon the overall system configuration. Moreover, the large combustion temperature operability range with secondary combustion may allow loading the gas turbine engine to follow an efficient load path with further improvements due to the bypass air.

The inlet guide vanes may be open to a maximum at near about eighty percent (80%) of load for evaluated configurations which is an improvement over current multistage designs. After reaching the full inlet guide vane position, the secondary combustion fuel may be increased to hold emissions substantially constant. As full combustion temperatures are reached, the bypass air may be shut down so as to remain emissions compliant. The bypass air also may be shut off in the steam augmentation mode to improve load and cycle efficiency. As the steam is increased, the secondary combustion fuel may be decreased so as to improve emissions or operability. Other types of loading schemes may be used herein. Other components and other configurations may be used herein.

The use of the common auxiliary system manifold 120 thus may improve cycle efficiency, emissions compliant load range, and overall emissions. The common auxiliary system manifold 120 provides overall operational flexibility in peak, base, and part load operations. Specifically, each auxiliary system 110 herein may be used to improve performance during loading and otherwise while the common auxiliary system manifold 120 provides a simplified design to accommodate the different systems and functionality. Any type and number of auxiliary systems 110 may be accommodated herein.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof.

We claim:

1. A gas turbine engine, comprising:
a compressor;
a combustor;
a plurality of auxiliary systems; and
a common auxiliary system manifold in communication with the compressor, the combustor, and the plurality of auxiliary systems.

2. The gas turbine engine of claim 1, wherein the plurality of auxiliary systems comprises an inlet bleed heat system positioned about the compressor.

3. The gas turbine engine of claim 2, wherein inlet bleed heat system comprises an inlet bleed heat extraction line in communication with the common auxiliary system manifold.

4. The gas turbine engine of claim 2, wherein the common auxiliary system manifold comprises a manifold extraction line in communication with the inlet bleed heat system.

5. The gas turbine engine of claim 4, wherein the common auxiliary system manifold comprises a three-way valve in communication with the manifold extraction line.

6. The gas turbine engine of claim 5, wherein the common auxiliary system manifold comprises a manifold bypass line in communication with the three-way valve.

7. The gas turbine engine of claim 6, wherein the manifold bypass line is in communication with the combustor.

8. The gas turbine engine of claim 1, wherein the plurality of auxiliary systems comprises a steam augmentation system.

9. The gas turbine engine of claim 8, wherein the steam augmentation system comprises a steam line in communication with the common auxiliary system manifold.

10. The gas turbine engine of claim 1, wherein the plurality of auxiliary systems comprises a secondary combustion system.

11. The gas turbine engine of claim 10, wherein the secondary combustion system comprises a secondary fuel line in communication with the common auxiliary system manifold.

12. The gas turbine engine of claim 11, wherein the secondary fuel line is coaxially positioned within the common auxiliary system manifold.

13. The gas turbine engine of claim 1, wherein the common auxiliary system manifold comprises a plurality of entry ports into the combustor.

14. The gas turbine engine of claim 1, wherein the common auxiliary system manifold comprises a gap about the combustor.

15. A method of operating a gas turbine engine, comprising:
providing a common auxiliary system manifold in communication with a compressor and a combustor of the gas turbine engine;
providing a flow of compressor discharge air to the common auxiliary system manifold; and
directing the flow of compressor discharge air to an inlet bleed heat system positioned about the compressor and to the combustor as a bypass flow.

16. A gas turbine engine, comprising:
a compressor;
a combustor;
a plurality of auxiliary systems; and
a common auxiliary system manifold;
the common auxiliary system manifold comprising a manifold extraction line, a manifold bypass line, and a three-way valve therebetween.

17. The gas turbine engine of claim 16, wherein the plurality of auxiliary systems comprises an inlet bleed heat system positioned about the compressor and in communication with the manifold extraction line of the common auxiliary system manifold.

18. The gas turbine engine of claim 16, wherein the plurality of auxiliary systems comprises a steam augmentation system in communication with the manifold bypass line of the common auxiliary system manifold.

19. The gas turbine engine of claim 16, wherein the plurality of auxiliary systems comprises a secondary combustion system in communication with the manifold bypass line of the common auxiliary system manifold.

20. The gas turbine engine of claim 19, wherein the secondary combustion system comprises a secondary fuel line coaxially positioned within the common auxiliary system manifold.
